(19) United States
(12) Patent Application Publication
(10) Pub. No.: US 2026/0101261 A1
(43) Pub. Date: Apr. 9, 2026

(54) SECURITY HANDLING FOR SUBSEQUENT MOBILITY

(71) Applicant: LG ELECTRONICS INC., Seoul (KR)

(72) Inventors: Hongsuk KIM, Seoul (KR); Geumsan JO, Seoul (KR)

(73) Assignee: LG ELECTRONICS INC., Seoul (KR)

(21) Appl. No.: 19/110,668

(22) PCT Filed: Sep. 25, 2023
(86) PCT No.: PCT/KR2023/014594

§ 371 Date: Mar. 11, 2025

Related U.S. Application Data
(60) Provisional application No. 63/411,131, filed on Sep. 29, 2022.

(51) Int. Cl. H04W 36/36; H04W 12/10; H04W 36/00

(52) U.S. Cl. CPC H04W 36/362; H04W 12/10; H04W 36/0038

(57) ABSTRACT

A method and apparatus for security handling for subsequent mobility procedure is provided. A wireless device receives a security mode command including a security configuration from a network, receives information informing whether a target cell belongs to a security group from the network, and continues using the security configuration based on the information informing that the target cell belongs to the security group.

### CROSS-REFERENCE TO RELATED APPLICATIONS

This application is the National Stage filing under 35 U.S.C. 371 of International Application No. PCT/KR2023/014594, filed on Sep. 25, 2023, which claims the benefit of U.S. Provisional Application No. 63/411,131 filed on Sep. 29, 2022, the contents of which are all hereby incorporated by reference herein in their entireties.

### TECHNICAL FIELD

The present disclosure relates to security handling for subsequent mobility procedure.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In Rel-17 Conditional Secondary Cell (PSCell) change (CPC)/Conditional PSCell Addition (CPA), a CPC/CPA-configured User Equipment (UE) has to release the CPC/CPA configurations when completing random access towards the target PSCell. Hence, the UE does not have a chance to perform subsequent CPC/CPA without prior CPC/CPA reconfiguration and re-initialization from the network. This will increase the delay for the cell change and increase the signaling overhead, especially in the case of frequent Secondary Cell Group (SCG) changes when operating Frequency Range-2 (FR2).

In Rel-18, 3GPP aims to support an optimized mobility procedure for the UE without receiving additional reconfiguration and performing re-initialization using the given conditional mobility commands. This means that the UE may maintain the given conditional mobility commands regardless of the change of the serving cells and use the conditional mobility commands whenever the condition is met. That is, multiple subsequent mobilities may be allowed based on the given conditional mobility command.

### SUMMARY

The present disclosure is to provide a method and apparatus for handling security update for subsequent mobility.

In an aspect, a method performed by a wireless device adapted to operate in a wireless communication system is provided. The method comprises receiving a security mode command including a security configuration from a network, receiving information informing whether a target cell belongs to a security group from the network, and continuing using the security configuration based on the information informing that the target cell belongs to the security group.

In another aspect, an apparatus for implementing the above method is provided.

The present disclosure may have various advantageous effects.

For example, when performing subsequent mobility, security reuse problem can be resolved by cell group-based security information handling.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of UE to which implementations of the present disclosure are applied.

FIGS. 4 and 5 show an example of protocol stacks in a 3GPP based wireless communication system to which implementations of the present disclosure are applied.

FIG. 6 shows a frame structure in a 3GPP based wireless communication system to which implementations of the present disclosure are applied.

FIG. 7 shows a data flow example in the 3GPP NR system to which implementations of the present disclosure are applied.

FIG. 8 shows an example of MR-DC with selective activation of cell groups to which implementations of the present disclosure are applied.

FIG. 9 shows an example of a method performed by a wireless device to which implementations of the present disclosure are applied.

FIG. 10 shows an example of a method performed by a base station to which implementations of the present disclosure are applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in Downlink (DL) and SC-FDMA in Uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

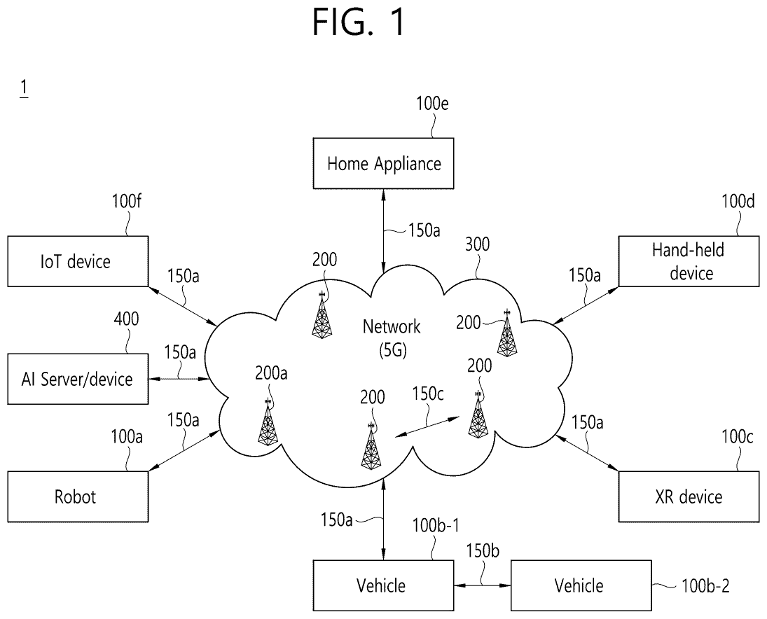

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include Narrow Band IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

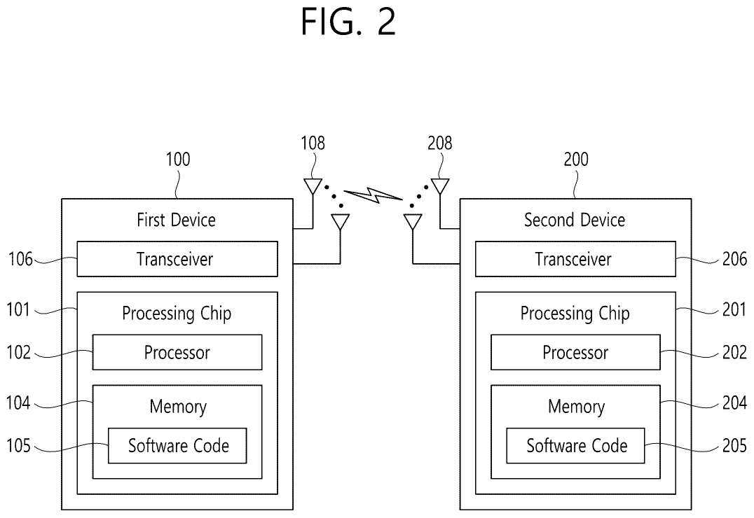

FIG. 2 shows an example of wireless devices to which implementations of the present disclosure are applied.

In FIG. 2. The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

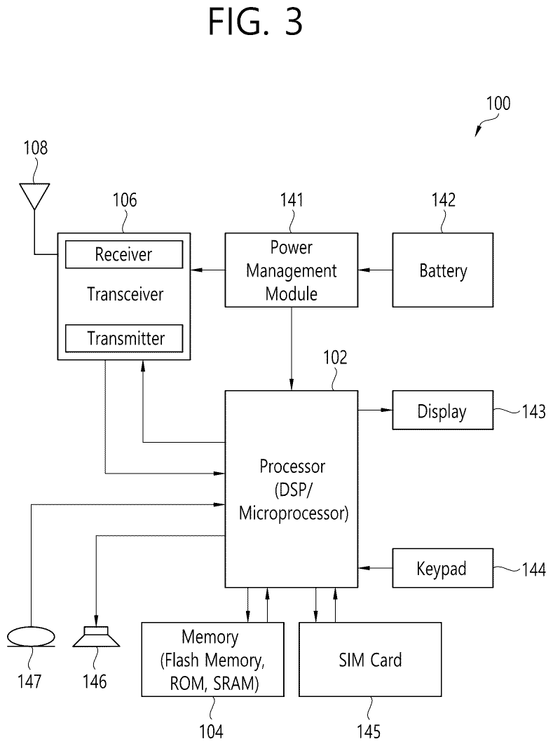

FIG. 3 shows an example of UE to which implementations of the present disclosure are applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

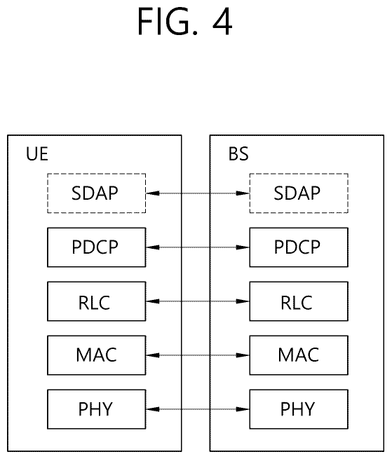

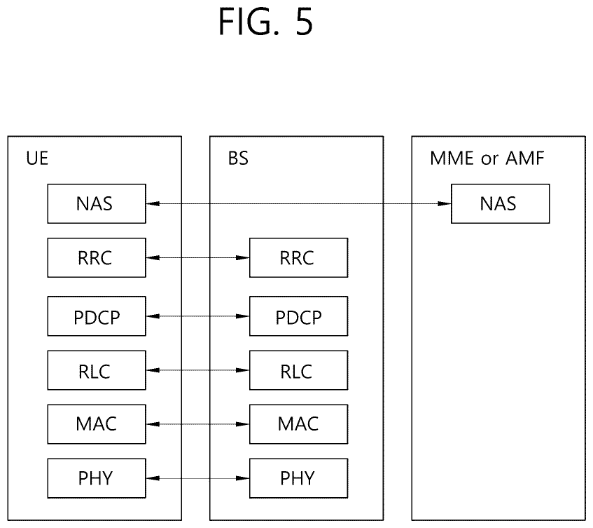

FIGS. 4 and 5 show an example of protocol stacks in a 3GPP based wireless communication system to which implementations of the present disclosure are applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

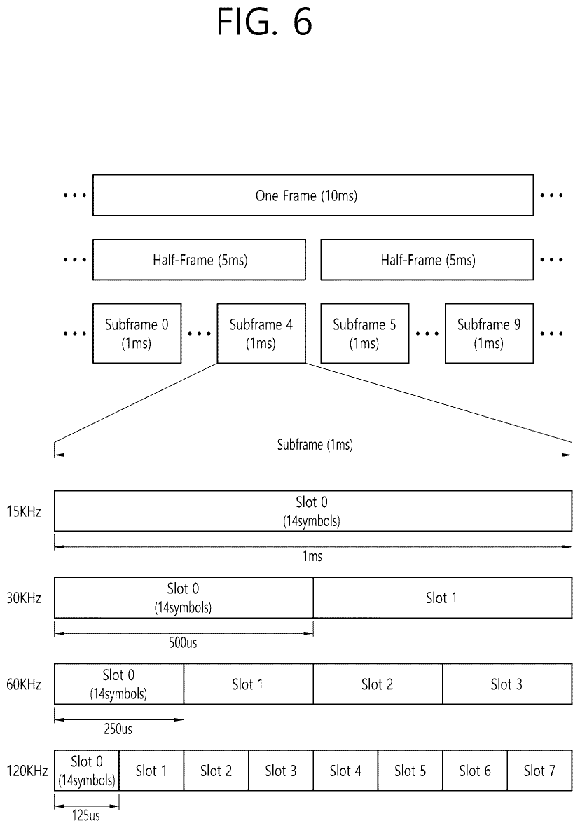

FIG. 6 shows a frame structure in a 3GPP based wireless communication system to which implementations of the present disclosure are applied.

The frame structure shown in FIG. 6 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is Ims. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 KHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{Size}_{BWP,i}, Where N^{size}_{BWP,i} is the common resource block where bandwidth part starts relative to CRB 0). The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL Component Carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell (SpCell). The configured set of serving cells for a UE therefore always consists of one PCell and one or more SCells. For Dual Connectivity (DC) operation, the term SpCell refers to the PCell of the Master Cell Group (MCG) or the Primary SCell (PSCell) of the Secondary Cell Group (SCG). An SpCell supports Physical Uplink Control Channel (PUCCH) transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

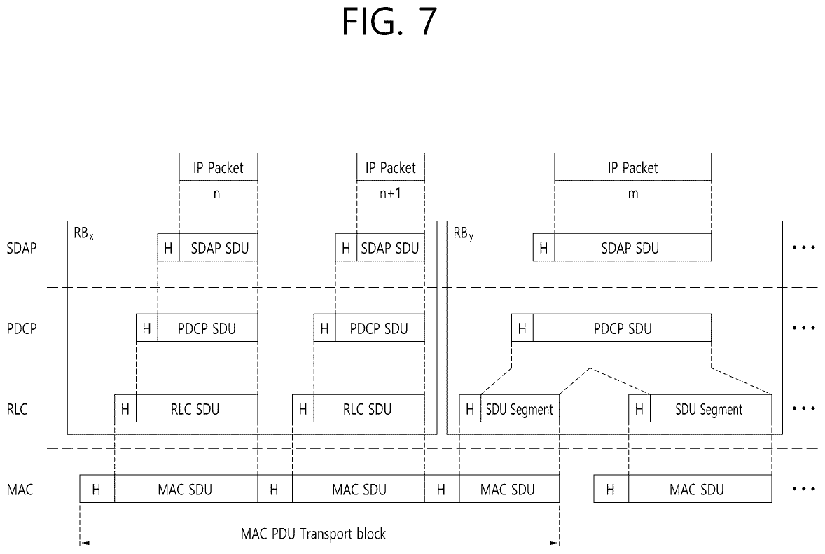

FIG. 7 shows a data flow example in the 3GPP NR system to which implementations of the present disclosure are applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Network controlled mobility applies to UEs in RRC_CONNECTED and is categorized into two types of mobility: cell level mobility and beam level mobility. Beam level mobility includes intra-cell beam level mobility and inter-cell beam level mobility.

Cell level mobility requires explicit RRC signaling to be triggered, i.e., handover. For inter-gNB handover, the signaling procedures consist of at least the following operations.
1. The source gNB initiates handover and issues a HANDOVER REQUEST message over the Xn interface.
2. The target gNB performs admission control and provides the new RRC configuration as part of the HANDOVER REQUEST ACKNOWLEDGE message.
3. The source gNB provides the RRC configuration to the UE by forwarding the RRC Reconfiguration message received in the HANDOVER REQUEST ACKNOWLEDGE message. The RRCReconfiguration message includes at least cell identity (ID) and all information required to access the target cell so that the UE can access the target cell without reading system information. For some cases, the information required for contention-based and contention-free random access can be included in the RRCReconfiguration message. The access information to the target cell may include beam specific information, if any.
4. The UE moves the RRC connection to the target gNB and replies with the RRCReconfigurationComplete message.

In case of Dual Active Protocol Stack (DAPS) handover, the UE continues the DL user data reception from the source gNB until releasing the source cell and continues the UL user data transmission to the source gNB until successful random access procedure to the target gNB.

Only source and target PCell are used during DAPS handover. CA, DC, Supplementary UL (SUL), multi-Transmission/Reception Point (TRP), Ethernet Header Compression (EHC), Conditional Handover (CHO), User Data Convergence (UDC), NR sidelink configurations and V2X sidelink configurations are released by the source gNB before the handover command is sent to the UE and are not configured by the target gNB until the DAPS handover has completed (i.e., at earliest in the same message that releases the source PCell).

The handover mechanism triggered by RRC requires the UE at least to reset the MAC entity and re-establish RLC, except for DAPS handover, where upon reception of the handover command, the UE:
Creates a MAC entity for target;
Establishes the RLC entity and an associated DTCH logical channel for target for each DRB configured with DAPS;
For each DRB configured with DAPS, reconfigures the PDCP entity with separate security and ROHC functions for source and target and associates them with the RLC entities configured by source and target respectively;
Retains the rest of the source configurations until release of the source.

RRC managed handovers with and without PDCP entity re-establishment are both supported. For DRBs using RLC AM mode, PDCP can either be re-established together with a security key change or initiate a data recovery procedure without a key change. For DRBs using RLC UM mode, PDCP can either be re-established together with a security key change or remain as it is without a key change. For SRBs, PDCP can either remain as it is, discard its stored PDCP PDUs/SDUs without a key change or be re-established together with a security key change.

Data forwarding, in-sequence delivery and duplication avoidance at handover can be guaranteed when the target gNB uses the same DRB configuration as the source gNB.

Timer based handover failure procedure is supported in NR. RRC connection re-establishment procedure is used for recovering from handover failure except in certain CHO or DAPS handover scenarios:
When DAPS handover fails, the UE falls back to the source cell configuration, resumes the connection with the source cell, and reports DAPS handover failure via the source without triggering RRC connection re-establishment if the source link has not been released.
When initial CHO execution attempt fails or HO fails, the UE performs cell selection, and if the selected cell is a CHO candidate and if network configured the UE to try CHO after handover/CHO failure, then the UE attempts CHO execution once, otherwise re-establishment is performed.

Beam level mobility does not require explicit RRC signaling to be triggered. Beam level mobility can be within a cell, or between cells, the latter is referred to as Inter-Cell Beam Management (ICBM). For ICBM, a UE can receive or transmit UE dedicated channels/signals via a TRP associated with a Physical Cell ID (PCI) different from the PCI of a serving cell, while non-UE-dedicated channels/signals can only be received via a TRP associated with a PCI of the serving cell. The gNB provides via RRC signaling the UE with measurement configuration containing configurations of Synchronization Signal Block (SSB)/Channel State Information (CSI) resources and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and MAC layer control signaling, and RRC is not required to know which beam is being used at a given point in time.

SSB-based beam level mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.

CHO is defined as a handover that is executed by the UE when one or more handover execution conditions are met. The UE starts evaluating the execution condition(s) upon receiving the CHO configuration, and stops evaluating the execution condition(s) once a handover is executed.

The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5). Only single Reference Signal (RS) type is supported and at most two different trigger quantities (e.g., Reference Signal Received Power (RSRP) and Reference Signal Received Quality (RSRQ), RSRP and Signal-to-Noise plus Interference Ratio (SINR), etc.) can be configured simultaneously for the evaluation of CHO execution condition of a single candidate cell.
Before any CHO execution condition is satisfied, upon reception of HO command (without CHO configuration), the UE executes the HO procedure, regardless of any previously received CHO configuration.
While executing CHO, i.e., from the time when the UE starts synchronization with target cell, the UE does not monitor source cell.

AS security comprises of the integrity protection and ciphering of SRBs and DRBs.

RRC handles the configuration of the AS security parameters which are part of the AS configuration: the integrity protection algorithm, the ciphering algorithm, if integrity protection and/or ciphering is enabled for a DRB and two parameters, namely the keySetChangeIndicator and the nextHopChainingCount, which are used by the UE to determine the AS security keys upon reconfiguration with sync (with key change), connection re-establishment and/or connection resume.

The integrity protection algorithm is common for SRB1, SRB2, SRB3 (if configured), SRB4 (if configured) and DRBs configured with integrity protection, with the same keyToUse value. The ciphering algorithm is common for SRB1, SRB2, SRB3 (if configured), SRB4 (if configured) and DRBs configured with the same keyToUse value. Neither integrity protection nor ciphering applies for SRB0.

All DRBs related to the same PDU session have the same enable/disable setting for ciphering and the same enable/disable setting for integrity protection.

RRC integrity protection and ciphering are always activated together, i.e., in one message/procedure. RRC integrity protection and ciphering for SRBs are never deactivated. However, it is possible to switch to a ‘NULL’ ciphering algorithm (nea0).

The ‘NULL’ integrity protection algorithm (nia0) is used only for SRBs and for the UE in limited service mode, and when used for SRBs, integrity protection is disabled for DRBs. In case the ‘NULL’ integrity protection algorithm is used, ‘NULL’ ciphering algorithm is also used.

Lower layers discard RRC messages for which the integrity protection check has failed and indicate the integrity protection verification check failure to RRC.

The AS applies four different security keys: one for the integrity protection of RRC signaling (K_{RRCint}), one for the ciphering of RRC signaling (K_{RRCenc}), one for integrity protection of user data (K_{UPint}) and one for the ciphering of user data (K_{UPenc}). All four AS keys are derived from the K_{gNB} key. The K_{gNB} key is based on the KAME key, which is handled by upper layers.

The integrity protection and ciphering algorithms can only be changed with reconfiguration with sync. The AS keys (K_{gNB}, K_{RRCint}, K_{RRCenc}, K_{UPint} and K_{UPenc}) change upon reconfiguration with sync (if masterKeyUpdate is included), and upon connection re-establishment and connection resume.

For each radio bearer, an independent counter (COUNT) is maintained for each direction. For each radio bearer, the COUNT is used as input for ciphering and integrity protection.

It is not allowed to use the same COUNT value more than once for a given security key. The network is responsible for avoiding reuse of the COUNT with the same RB identity and with the same key, e.g., due to the transfer of large volumes of data, release and establishment of new RBs, and multiple termination point changes for RLC-UM bearers and multiple termination point changes for RLC-AM bearer with SN terminated PDCP re-establishment (COUNT reset) due to SN only full configuration whilst the key stream inputs (i.e., bearer ID, security key) at MN have not been updated. In order to avoid such re-use, the network may, e.g., use different RB identities for RB establishments, change the AS security key, or an RRC_CONNECTED to RRC_IDLE/RRC_INACTIVE and then to RRC_CONNECTED transition.

In order to limit the signaling overhead, individual messages/packets include a short sequence number (PDCP SN). In addition, an overflow counter mechanism is used: Hyper Frame Number (HFN). The HFN needs to be synchronized between the UE and the network.

For each SRB, the value provided by RRC to lower layers to derive the 5-bit BEARER parameter used as input for ciphering and for integrity protection is the value of the corresponding srb-Identity with the MSBs padded with zeroes.

For a UE provided with an sk-Counter, keyToUse indicates whether the UE uses the master key (K_{gNB}) or the secondary key (S-K_{eNB} or S-K_{gNB}) for a particular DRB. The secondary key is derived from the master key and sk-Counter. Whenever there is a need to refresh the secondary key, e.g., upon change of MN with K_{gNB} change or to avoid COUNT reuse, the security key update is used. When the UE is in NR-DC, the network may provide a UE configured with an SCG with an sk-Counter even when no DRB is setup using the secondary key (S-K_{gNB}) in order to allow the configuration of SRB3. The network can also provide the UE with an sk-Counter, even if no SCG is configured, when using SN terminated MCG bearers.

For AS security key update, the UE may:
1> if UE is connected to E-UTRA/EPC or E-UTRA/5GC:
2> upon reception of sk-Counter:
3> update the S-K_{gNB} key based on the K_{eNB} key and using the received sk-Counter value;
3> derive the K_{RRCenc} and K_{UPenc} keys;
3> derive the K_{RRCint} and K_{UPint} keys.
1> else if this procedure was initiated due to reception of the masterKeyUpdate:
2> if the nas-Container is included in the received masterKeyUpdate:
3> forward the nas-Container to the upper layers;
2> if the keySetChangeIndicator is set to true:
3> derive or update the K_{gNB} key based on the K_{AMF} key;
2> else:
3> derive or update the K_{gNB} key based on the current K_{gNB} key or the NH, using the nextHopChainingCount value indicated in the received master KeyUpdate;
2> store the nextHopChainingCount value;
2> derive the keys associated with the K_{gNB} key as follows:
3> if the securityAlgorithmConfig is included in SecurityConfig:
4> derive the K_{RRCenc} and K_{UPenc} keys associated with the cipheringAlgorithm indicated in the securityAlgorithmConfig;
4> derive the K_{RRCint} and K_{UPint} keys associated with the integrityProtAlgorithm indicated in the securityAlgorithmConfig;
3> else:
4> derive the K_{RRCene} and K_{UPenc} keys associated with the current cipheringAlgorithm;
4> derive the K_{RRCint} and K_{UPint} keys associated with the current integrityProtAlgorithm.
1> else if this procedure was initiated due to reception of the sk-Counter (UE is in NE-DC, or NR-DC, or is configured with SN terminated bearer(s)):
2> derive or update the secondary key (S-K_{gNB} or S-K_{eNB}) based on the K_{gNB} key and using the received sk-Counter value;
2> derive the K_{RRCene} key and the K_{UPenc} key using the ciphering algorithms indicated in the RadioBearerConfig associated with the secondary key (S-K_{gNB} or S-K_{eNB}) as indicated by keyToUse;
2> derive the K_{RRCint} key and the K_{UPint} key using the integrity protection algorithms indicated in the RadioBearerConfig associated with the secondary key (S-K_{gNB} or S-K_{eNB}) as indicated by keyToUse;

It has been discussed to introduce subsequent mobility in Rel-18. In subsequent mobility, the UE may maintain the given conditional mobility commands regardless of the change of the serving cells and use the conditional mobility commands whenever the condition is met. Therefore, without receiving additional reconfiguration and performing re-initialization using the given conditional mobility commands, the UE can perform one or more subsequent mobilities based on the given conditional mobility command.

Multi-Radio (MR)-DC with selective activation of cell groups aims at enabling subsequent Conditional PSCell Change (CPC)/Conditional PSCell Addition (CPA) after SCG change, without reconfiguration and re-initialization on the CPC/CPA preparation from the network. This results in a reduction of the signalling overhead and interrupting time for SCG change.

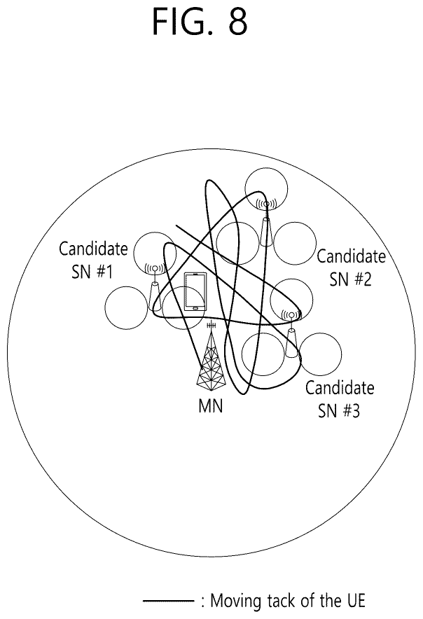

FIG. 8 shows an example of MR-DC with selective activation of cell groups to which implementations of the present disclosure are applied.

One typical scenario regarding an example of FIG. 8 may be that the UE moves around within the coverage of several micro gNBs and one macro gNB. To reduce signaling overhead and interrupting time for SCG/PSCell change, the UE may continue evaluating the conditional reconfiguration for SCG, and accordingly, subsequent CPC may performed based on previous CPC/CPA configurations which is not released after the previous PSCell change/addition procedure.

Referring to FIG. 8, the UE may move back and forth within the coverage of several micro gNBs, and it is possible that the UE changes to the same PSCell for more than one time. This implies that the conditional reconfiguration for the same candidate PSCell may be applied more than one time. In this case, there may be security key reuse issue.

For example, to update security keys for the SN, the MN may generate the K_{SN} for the SN and sends it to the SN over the Xn-C. To generate the K_{SN}, the MN associates a counter, sk-Counter. And, the K_{SN} is generated based on the security key of the MN and sk-Counter. The MN sends the value of the sk-Counter to the UE over the RRCRconfiguration. That is, the security of the SN only depends on sk-Counter and the security key of the MN.

For subsequent CPC, the stored secondary key configuration (e.g., sk-Counter) in the conditional reconfiguration for CPC is used. Therefore, for multiple times of subsequent CPC on the same candidate PSCell, if the same sk-Counter stored in in the conditional reconfiguration for CPC is used, the same security key may be generated. Different packets may be ciphered with same security key and PDCP COUNT value, which is not allowed, and this would result in security key reuse issue.

Additionally, sk-Counter may be monotonically increased by the MN for each additional calculated K_{SN}. However, for the case of subsequent CPC, since the moving tack of the UE is random, it may not be possible for the network to configure appropriate sk-Counter for each candidate PSCell to fulfil the monotonically increment principle.

In other words, information for the subsequent mobility (e.g., conditional mobility command and/or UE variable VarConditionalReconfig) may be maintained whenever mobility is performed. Thus, when the UE keeps changing serving cells in subsequent mobility, the UE may not update the security configuration which has been used in the previous serving cell, and accordingly, the same security key value and sk-Counter may be reused. The reused security key may cause a security problem, e.g., when another packet is transmitted based on the same security configuration. This is because, if there is no security update for the next mobility from the network, the cell configuration including the security information initially provided may be used as it is. This security problem may especially occur when the previous serving cell becomes a target cell again while continuously performing the subsequent mobility.

Therefore, a way to prevent a case where the security key is reused needs to be addressed.

According to implementations of the present disclosure, the UE may check whether a target cell is in a cell list for which group security information is allowed when performing mobility. The cell list for which group security information is allowed may be called security group. If the target cell is in the cell list and the UE is using the group security information in the current cell (i.e., source cell), the UE may maintain the current security information without security update. Otherwise, if the target cell is not in the cell list but the UE is using the group security key information in the current cell (i.e., source cell), the UE may update the security information according to the security configuration in a mobility command (i.e., RRC Reconfiguration with reconfiguration WithSync) for the target cell. After the update of the security information, the UE may inform the target cell that the UE had used the group security information in the source cell. The UE may indicate to the network that the UE maintains the group security information for the next mobility.

According to implementations of the present disclosure, for the group security information, the network may provide the at least one of the followings.
Ciphering algorithm: may indicate the ciphering algorithm to be used for SRBs and DRBs
Integrity algorithm: may indicate the integrity protection algorithm to be used for SRBs and DRBs
Key to use: may indicate radio bearers related to this security information are using a master key (e.g., K_{gNB} or K_{eNB}) or a secondary key (e.g., S-K_{gNB} or S-K_{eNB}) for deriving ciphering and/or integrity protection keys.
sk-Counter: may indicate a counter used upon initial configuration of S-K_{gNB} or S-K_{eNB}, as well as upon refresh of S-K_{gNB} or S-K_{eNB}.
Key set change indicator: may indicate whether UE shall derive a new K_{gNB}. If reconfigurationWithSync is included, value true may indicate that a K_{gNB} key is derived from a K_{AMF} key taken into use through the latest successful NAS Security Mode Command (SMC) procedure, or N2 handover procedure with K_{AMF} change for K_{gNB} re-keying. Value false may indicate that the new K_{gNB} key is obtained from the current K_{gNB} key or from the Next Hop (NH).
Next Hop Chaining Count: may be used to update the K_{gNB} key.
Cell list: may indicate a list of cells to which this group security information can be applied. For all cells in the cell list, all mobility commands for the cells may include the same group security information (because the network cannot decide which cell will be selected for the subsequent mobility).

The network may provide the cell list in the group security information which is same as a cell list for subsequent mobility. If the cell list for the group security information is same as the cell list for the subsequent mobility, the network may provide a single cell list for both the group security information and the subsequent mobility, instead of providing two same cell list.

According to implementations of the present disclosure, when the UE performs mobility with a target cell included in the cell list, the current security key may be continuously used without security key change. The UE may use the current security key without security key change if the group security has been activated and the security configuration in the mobility command for the subsequent mobility is the same information of the group security. In addition, the UE may not reset the PDCP count value. Also, even if there is any security information to update in a mobility command for the target cell, the UE may discard the security information to update in the mobility command for the target cell because the UE maintains the current security key.

According to implementations of the present disclosure, when the UE performs mobility with another target cell not included in the cell list, the UE may check if the network explicitly commands the UE to perform mobility without security key update (i.e., without security key refresh). If there is no explicit indication to perform a mobility without security key change in a mobility command for another target cell, the UE may update security key. That is, the UE may update the K_{gNB} or S-K_{gNB} and use new sk-Counter (if received), newly derive K_{RRCenc} and K_{UPenc} keys, K_{RRCint} and K_{UPint} keys. After security update, the UE may transmit a dedicated RRC signaling, e.g., RRCReconfigurationComplete message, to indicate that the UE still maintains the group security information for next subsequent mobility.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

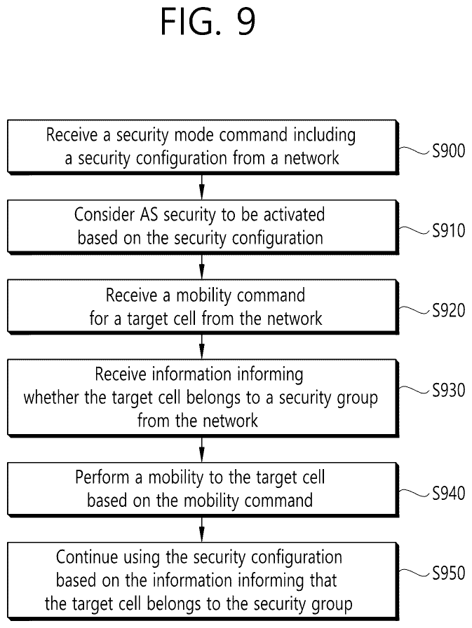

FIG. 9 shows an example of a method performed by a wireless device to which implementations of the present disclosure are applied.

In step S900, the method comprises receiving a security mode command including a security configuration from a network.

In step S910, the method comprises considering AS security to be activated based on the security configuration.

In step S920, the method comprises receiving a mobility command for a target cell from the network.

In step S930, the method comprises receiving information informing whether the target cell belongs to a security group from the network.

In step S940, the method comprises performing a mobility to the target cell based on the mobility command.

In step S950, the method comprises continuing using the security configuration based on the information informing that the target cell belongs to the security group.

In some implementations, the information may be received by being included in group security information. The group security information may include at least one of a ciphering algorithm, an integrity algorithm, a key to use, Sk-Counter, a key set change indicator or NCC.

In some implementations, the information may correspond to a list of cells to which the group security information can be applied. All mobility commands for all target cells included in the list of cells may include same group security information. The list of cells to which the group security information can be applied may be same as a list of cells for subsequent mobility.

In some implementations, the method may further comprise checking whether the target cell is in the security group and the wireless device is using the group security information in a source cell.

In some implementations, continuing using the security configuration may comprise maintaining current security information without AS security update.

In some implementations, the method may further comprise updating the AS security according to a second security configuration based on the information informing that the target cell does not belong to the security group. The second security configuration may be received via the mobility command for the target cell. The method may further comprise informing the target cell that the wireless device had used the group security information in a source cell. The method may further comprise informing the target cell that the wireless device maintains the group security information for next mobility.

In some implementations, the wireless device may be in communication with at least one of a mobile device, a network, and/or autonomous vehicles other than the wireless device.

Furthermore, the method in perspective of the wireless device described above in FIG. 9 may be performed by the first wireless device 100 shown in FIG. 2 and/or the UE 100 shown in FIG. 3.

The wireless device comprises at least one transceiver, at least one processor, and at least one memory operably connectable to the at least one processor and storing instructions that, based on being executed by the at least one processor, perform the method described in FIG. 9.

More specifically, the wireless device receives a security mode command including a security configuration from a network.

The wireless device considers AS security to be activated based on the security configuration.

The wireless device receives a mobility command for a target cell from the network.

The wireless device receives information informing whether the target cell belongs to a security group from the network.

The wireless device performs a mobility to the target cell based on the mobility command.

The wireless device continues using the security configuration based on the information informing that the target cell belongs to the security group.

In some implementations, the information may be received by being included in group security information. The group security information may include at least one of a ciphering algorithm, an integrity algorithm, a key to use, Sk-Counter, a key set change indicator or NCC.

In some implementations, the information may correspond to a list of cells to which the group security information can be applied. All mobility commands for all target cells included in the list of cells may include same group security information. The list of cells to which the group security information can be applied may be same as a list of cells for subsequent mobility.

In some implementations, the wireless device may further check whether the target cell is in the security group and the wireless device is using the group security information in a source cell.

In some implementations, continuing using the security configuration may comprise maintaining current security information without AS security update.

In some implementations, the wireless device may further update the AS security according to a second security configuration based on the information informing that the target cell does not belong to the security group. The second security configuration may be received via the mobility command for the target cell. The wireless device may further inform the target cell that the wireless device had used the group security information in a source cell. The wireless device may further inform the target cell that the wireless device maintains the group security information for next mobility.

Furthermore, the method in perspective of the wireless device described above in FIG. 9 may be performed by control of the processor 102 included in the first wireless device 100 shown in FIG. 2 and/or by control of the processor 102 included in the UE 100 shown in FIG. 3.

A processing apparatus adapted to control a wireless device comprises at least one processor, and at least one memory operably connectable to the at least one processor. The at least one processor is adapted to perform the method described in FIG. 9.

Furthermore, the method in perspective of the wireless device described above in FIG. 9 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as Synchronous DRAM (SDRAM), ROM, Non-Volatile RAM (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory Computer-Readable Medium (CRM) stores instructions that, based on being executed by at least one processor, perform the method described in FIG. 9.

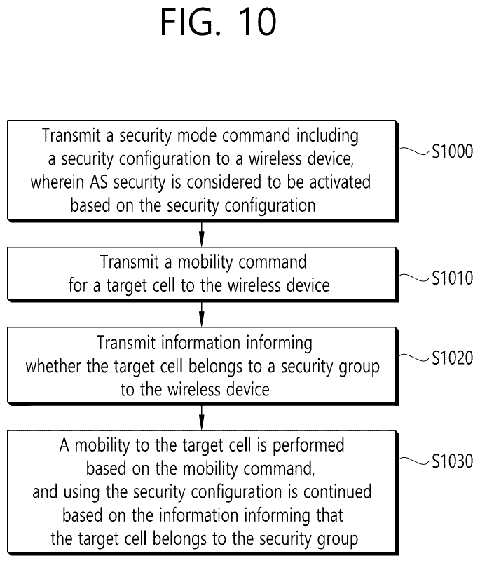

FIG. 10 shows an example of a method performed by a base station to which implementations of the present disclosure are applied.

In step S1000, the method comprises transmitting a security mode command including a security configuration to a wireless device. AS security is considered to be activated based on the security configuration.

In step S1010, the method comprises transmitting a mobility command for a target cell to the wireless device.

In step S1020, the method comprises transmitting information informing whether the target cell belongs to a security group from the network.

In step S1030, a mobility to the target cell is performed based on the mobility command, and using the security configuration is continued based on the information informing that the target cell belongs to the security group.

Furthermore, the method in perspective of the base station serving a second serving cell described above in FIG. 10 may be performed by the second wireless device 200 shown in FIG. 2.

The base station comprises at least one transceiver, at least one processor, and at least one memory operably connectable to the at least one processor and storing instructions that, based on being executed by the at least one processor, perform the method described in FIG. 10.

More specifically, the base station transmits a security mode command including a security configuration to a wireless device. AS security is considered to be activated based on the security configuration.

The base station transmits a mobility command for a target cell to the wireless device.

The base station transmits information informing whether the target cell belongs to a security group from the network.

A mobility to the target cell is performed based on the mobility command, and using the security configuration is continued based on the information informing that the target cell belongs to the security group.

An example of the UE operation according to the implementations of the present disclosure may be as follows.

Upon reception of an RRCReconfiguration by the UE, the UE may:
1> if the RRCReconfiguration includes the masterCellGroup:
2> perform the cell group configuration for the received masterCellGroup;
1> if the RRCReconfiguration includes the master KeyUpdate:
2> perform AS security key update procedure;
1> if the RRCReconfiguration includes the sk-Counter:
2> perform security key update procedure;
1> if the RRCReconfiguration includes the group security information:
2> perform AS security key update procedure;
1> if the RRCReconfiguration includes the secondaryCellGroup:
2> perform the cell group configuration for the SCG;

For AS Security key update, the UE may:
1> if the group security for subsequent mobility has been activated and this procedure was initiated due to reception of group security configuration:
2> use continuously the security configuration used without update of K_{gNB} or S-K_{gNB} or new derivation for K_{RRCene} and K_{UPenc} keys, and the K_{RRCint} and K_{UPint} keys;
1> else if the UE is connected to E-UTRA/EPC or E-UTRA/5GC:
2> upon reception of sk-Counter or sk-Counter of the group security:
3> update the S-K_{gNB} key based on the K_{eNB} key and using the received sk-Counter value;
3> derive the K_{RRCenc} and K_{UPenc} keys;
3> derive the K_{RRCint} and K_{UPint} keys.
1> else if this procedure was initiated due to reception of the master KeyUpdate or master KeyUpdate of the group security:
2> if the nas-Container is included in the received masterKeyUpdate:
3> forward the nas-Container to the upper layers;
2> if the keySetChangeIndicator is set to true:
3> derive or update the K_{gNB} key based on the K_{AMF} key];
2> else:
3> derive or update the K_{gNB} key based on the current K_{gNB} key or the NH, using the nextHopChainingCount value indicated in the received masterKeyUpdate;
2> store the nextHopChainingCount value;
2> derive the keys associated with the K_{gNB} key as follows:
3> if the securityAlgorithmConfig is included in SecurityConfig:
4> derive the K_{RRCene} and K_{UPenc} keys associated with the cipheringAlgorithm indicated in the securityAlgorithmConfig;
4> derive the K_{RRCint} and K_{UPint} keys associated with the integrityProtAlgorithm indicated in the securityAlgorithmConfig;
3> else:
4> derive the K_{RRCenc} and K_{UPenc} keys associated with the current cipheringAlgorithm;
4> derive the K_{RRCint} and K_{UPint} keys associated with the current integrityProtAlgorithm.
1> else if this procedure was initiated due to reception of the sk-Counter or sk-Counter of the group security (UE is in NE-DC, or NR-DC, or is configured with SN terminated bearer(s)):
2> derive or update the secondary key (S-K_{gNB} or S-K_{eNB}) based on the K_{gNB} key and using the received sk-Counter value;
2> derive the K_{RRCenc} key and the K_{UPenc} key using the ciphering algorithms indicated in the RadioBearerConfig associated with the secondary key (S-K_{gNB} or S-K_{eNB}) as indicated by keyToUse;
2> derive the K_{RRCint} key and the K_{UPint} key using the integrity protection algorithms indicated in the RadioBearerConfig associated with the secondary key (S-K_{gNB} or S-K_{eNB}) as indicated by keyToUse.

For SRB addition/modification, the UE may:
1> If any DAPS bearer is configured, for each SRB:
2> establish a PDCP entity for the target cell group, with the same configuration as the PDCP entity for the source cell group;
2> if the masterKeyUpdate is received and the group security for subsequent mobility has not been activated:
3> configure the PDCP entity with the security algorithms according to securityConfig and apply the keys (K_{RRCenc} and K_{RRCint}) associated with the master key (K_{gNB});
2> else:
3> configure the PDCP entity for the target cell group with state variables continuation, and with the same security configuration as the PDCP entity for the source cell group;
1> for each srb-Identity value included in the srb-ToAddModList that is not part of the current UE configuration (SRB establishment or reconfiguration from E-UTRA PDCP to NR PDCP):
2> establish a PDCP entity;
2> if AS security has been activated:
3> if target RAT of handover is E-UTRA/5GC; or
3> if the UE is connected to E-UTRA/5GC:
4> if the UE is capable of E-UTRA/5GC, but not capable of NGEN-DC:
5> configure the PDCP entity with the security algorithms and keys (K_{RRCenc} and K_{RRCint}) configured/derived;
4> else (i.e., UE capable of NGEN-DC):
5> configure the PDCP entity with the security algorithms according to securityConfig and apply the keys (K_{RRCene} and K_{RRCint}) associated with the master key (K_{eNB}) or secondary key (S-K_{gNB}) as indicated in keyToUse, if applicable;
3> else (i.e., UE connected to NR or UE connected to E-UTRA/EPC):
4> configure the PDCP entity with the security algorithms according to securityConfig and apply the keys (K_{RRCene} and K_{RRCint}) associated with the master key (K_{eNB}/K_{gNB}) or secondary key (S-K_{gNB}) as indicated in keyToUse, if applicable;
2> if the current UE configuration as configured by E-UTRA includes an SRB identified with the same srb-Identity value:
3> associate the E-UTRA RLC entity and DCCH of this SRB with the NR PDCP entity;
3> release the E-UTRA PDCP entity of this SRB;
2> if the pdcp-Config is included:
3> configure the PDCP entity in accordance with the received pdcp-Config;
2> else:
3> configure the PDCP entity in accordance with the default configuration for the corresponding SRB;
1> if any DAPS bearer is configured, for each srb-Identity value included in the srb-ToAddModList that is part of the current UE configuration:
2> if the pdcp-Config is included:
3> reconfigure the PDCP entity for the target cell group in accordance with the received pdcp-Config;
1> else, for each srb-Identity value included in the srb-ToAddModList that is part of the current UE configuration:
2> if the reestablishPDCP is set:
3> if target RAT of handover is E-UTRA/5GC; or
3> if the UE is connected to E-UTRA/5GC:
4> if the UE is capable of E-UTRA/5GC, but not capable of NGEN-DC:
5> configure the PDCP entity to apply the integrity protection algorithm and K_{RRCint} key configured/derived, i.e., the integrity protection configuration shall be applied to all subsequent messages received and sent by the UE, including the message used to indicate the successful completion of the procedure;
5> configure the PDCP entity to apply the ciphering algorithm and K_{RRCene} key configured/derived, i.e., the ciphering configuration shall be applied to all subsequent messages received and sent by the UE, including the message used to indicate the successful completion of the procedure;
4> else (i.e., a UE capable of NGEN-DC):
5> configure the PDCP entity to apply the integrity protection algorithm and K_{RRCint} key associated with the master key (K_{eNB}) or secondary key (S-K_{gNB}), as indicated in keyToUse, i.e., the integrity protection configuration shall be applied to all subsequent messages received and sent by the UE, including the message used to indicate the successful completion of the procedure;
5> configure the PDCP entity to apply the ciphering algorithm and K_{RRCenc} key associated with the master key (K_{eNB}) or secondary key (S-K_{gNB}) as indicated in keyToUse, i.e., the ciphering configuration shall be applied to all subsequent messages received and sent by the UE, including the message used to indicate the successful completion of the procedure;
3> else (i.e., UE connected to NR or UE in EN-DC):
4> configure the PDCP entity to apply the integrity protection algorithm and K_{RRCint} key associated with the master key (K_{eNB}/K_{gNB}) or secondary key (S-K_{gNB}), as indicated in keyToUse, i.e., the integrity protection configuration shall be applied to all subsequent messages received and sent by the UE, including the message used to indicate the successful completion of the procedure;
4> configure the PDCP entity to apply the ciphering algorithm and K_{RRCenc} key associated with the master key (K_{eNB}/K_{gNB}) or secondary key (S-K_{gNB}) as indicated in keyToUse, i.e., the ciphering configuration shall be applied to all subsequent messages received and sent by the UE, including the message used to indicate the successful completion of the procedure;
3> re-establish the PDCP entity of this SRB;
2> else, if the discardOnPDCP is set:
3> trigger the PDCP entity to perform SDU discard;
2> if the pdcp-Config is included:
3> reconfigure the PDCP entity in accordance with the received pdcp-Config.

For DRB addition/modification, the UE may:
1> for each drb-Identity value included in the drb-ToAddModList that is not part of the current UE configuration (DRB establishment including the case when full configuration option is used):
2> establish a PDCP entity and configure it in accordance with the received pdcp-Config;
2> if the PDCP entity of this DRB is not configured with cipheringDisabled:
3> if target RAT of handover is E-UTRA/5GC; or
3> if the UE is connected to E-UTRA/5GC:
4> if the UE is capable of E-UTRA/5GC but not capable of NGEN-DC:
5> configure the PDCP entity with the ciphering algorithm and K_{UPenc} key configured/derived;
4> else (i.e., a UE capable of NGEN-DC):
5> configure the PDCP entity with the ciphering algorithms according to securityConfig and apply the key (K_{UPenc}) associated with the master key (K_{eNB}) or secondary key (S-K_{gNB}) as indicated in keyToUse, if applicable;
3> else (i.e., UE connected to NR or UE connected to E-UTRA/EPC);
4> configure the PDCP entity with the ciphering algorithms according to securityConfig and apply the K_{UPenc} key associated with the master key (K_{eNB}/K_{gNB}) or the secondary key (S-K_{gNB}/S-K_{eNB}) as indicated in keyToUse;
2> if the PDCP entity of this DRB is configured with integrityProtection:
3> configure the PDCP entity with the integrity protection algorithms according to securityConfig and apply the K_{UPint} key associated with the master (K_{eNB}/K_{gNB}) or the secondary key (S-K_{gNB}) as indicated in keyToUse;
2> if an sdap-Config is included:
3> if an SDAP entity with the received pdu-Session does not exist:
4> establish an SDAP entity;
4> if an SDAP entity with the received pdu-Session did not exist prior to receiving this reconfiguration:
5> indicate the establishment of the user plane resources for the pdu-Session to upper layers;
3> configure the SDAP entity in accordance with the received sdap-Config and associate the DRB with the SDAP entity;
3> for each QFI value added in mappedQoS-FlowsToAdd, if the QFI value is previously configured, the QFI value is released from the old DRB;
2> if the DRB is associated with an eps-BearerIdentity:
3> if the DRB was configured with the same eps-Bearer Identity either by NR or E-UTRA prior to receiving this reconfiguration:
4> associate the established DRB with the corresponding eps-BearerIdentity;
3> else:
4> indicate the establishment of the DRB(s) and the eps-BearerIdentity of the established DRB(s) to upper layers;
1> for each drb-Identity value included in the drb-ToAddModList that is part of the current UE configuration and configured as DAPS bearer:
2> reconfigure the PDCP entity to configure DAPS with the ciphering function, integrity protection function and ROHC function of the target cell group and configure it in accordance with the received pdcp-Config;
2> if the masterKeyUpdate is received and the group security for subsequent mobility has not been activated:
3> if the ciphering function of the target cell group PDCP entity is not configured with cipheringDisabled:
4> configure the ciphering function of the target cell group PDCP entity with the ciphering algorithm according to securityConfig and apply the K_{UPenc} key associated with the master key (K_{gNB}), as indicated in keyToUse, i.e., the ciphering configuration shall be applied to all subsequent PDCP PDUs received from the target cell group and sent to the target cell group by the UE;
3> if the integrity protection function of the target cell group PDCP entity is configured with integrityProtection:
4> configure the integrity protection function of the target cell group PDCP entity with the integrity protection algorithms according to securityConfig and apply the K_{UPint} key associated with the master key (K_{gNB}) as indicated in keyToUse;
2> else:
3> configure the ciphering function and the integrity protection function of the target cell group PDCP entity with the same security configuration as the PDCP entity for the source cell group;
2> if the sdap-Config is included and when indication of successful completion of random access towards target cell is received from lower layers:
3> reconfigure the SDAP entity in accordance with the received sdap-Config;
3> for each QFI value added in mappedQoS-FlowsToAdd, if the QFI value is previously configured, the QFI value is released from the old DRB;
1> for each drb-Identity value included in the drb-ToAddModList that is part of the current UE configuration and not configured as DAPS bearer:
2> if the reestablishPDCP is set:
3> if target RAT of handover is E-UTRA/5GC; or
3> if the UE is connected to E-UTRA/5GC:
4> if the UE is capable of E-UTRA/5GC but not capable of NGEN-DC:
5> if the PDCP entity of this DRB is not configured with cipheringDisabled:
6> configure the PDCP entity with the ciphering algorithm and K_{UPenc} key configured/derived, i.e., the ciphering configuration shall be applied to all subsequent PDCP PDUs received and sent by the UE;
4> else (i.e., a UE capable of NGEN-DC):
5> if the PDCP entity of this DRB is not configured with cipheringDisabled:
6> configure the PDCP entity with the ciphering algorithm and K_{UPenc} key associated with the master key (K_{eNB}) or the secondary key (S-K_{gNB}), as indicated in keyToUse, i.e., the ciphering configuration shall be applied to all subsequent PDCP PDUs received and sent by the UE;
3> else (i.e., UE connected to NR or UE connected to E-UTRA/EPC (in EN-DC or capable of EN-DC)):
4> if the PDCP entity of this DRB is not configured with cipheringDisabled:
5> configure the PDCP entity with the ciphering algorithm and K_{UPenc} key associated with the master key (K_{eNB}/K_{gNB}) or the secondary key (S-K_{gNB}/S-K_{eNB}), as indicated in keyToUse, i.e., the ciphering configuration shall be applied to all subsequent PDCP PDUs received and sent by the UE;
4> if the PDCP entity of this DRB is configured with integrityProtection:
5> configure the PDCP entity with the integrity protection algorithms according to securityConfig and apply the K_{UPint} key associated with the master key (K_{eNB}/K_{gNB}) or the secondary key (S-K_{gNB}) as indicated in keyToUse;
3> if drb-ContinueROHC is included in pdcp-Config:
4> indicate to lower layer that drb-ContinueROHC is configured; 3> if drb-ContinueEHC-DL is included in pdcp-Config:
4> indicate to lower layer that drb-ContinueEHC-DL is configured;
3> if drb-ContinueEHC-UL is included in pdcp-Config:
4> indicate to lower layer that drb-ContinueEHC-UL is configured;
3> if drb-ContinueUDC is included in pdcp-Config:
4> indicate to lower layer that drb-ContinueUDC is configured;
3> re-establish the PDCP entity of this DRB;
2> else, if the recoverPDCP is set:
3> trigger the PDCP entity of this DRB to perform data recovery;
2> if the pdcp-Config is included:
3> reconfigure the PDCP entity in accordance with the received pdop-Config.
2> if the sdap-Config is included:
3> reconfigure the SDAP entity in accordance with the received sdap-Config;
3> for each QFI value added in mappedQoS-FlowsToAdd, if the QFI value is previously configured, the QFI value is released from the old DRB;

In response to reception of an RRCReconfiguration by the UE, the UE may:
1> set the content of the RRCReconfigurationComplete message as follows:
2> if the RRCReconfiguration includes the masterCellGroup or secondaryCellGroup containing masterKeyUpdate or sk-Counter which are not related to the group security key and the group security for subsequent mobility has been deactivated due to the masterKeyUpdate or sk-Counter:
3> include group security information to indicate that the UE maintains the group security configuration for next subsequent mobility.

The present disclosure may have various advantageous effects.

For example, when performing subsequent mobility, security reuse problem can be resolved by cell group-based security information handling.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-18. (canceled)

19. A method comprising:
receiving, by a wireless device, information related to a set of security cells for a Primary Secondary Cell (PSCell) from a network;
performing, by the wireless device, a subsequent Conditional PSCell Addition or Change (CPAC) with a target cell, which comprises:
based on the target cell not relating to the set of security cells, performing a security update.

20. The method of claim 19, wherein the information related to the set of security cells for the PSCell is received by being included in group security information.

21. The method of claim 20, wherein the information related to the set of security cells for the PSCell corresponds to a list of cells to which the group security information can be applied.

22. The method of claim 21, wherein all mobility commands for all target cells included in the list of cells include same group security information.

23. The method of claim 21, wherein the list of cells to which the group security information can be applied is same as a list of cells for the subsequent CPAC.

24. The method of claim 20, wherein the group security information includes at least one of a ciphering algorithm, an integrity algorithm, a key to use, Sk-Counter, a key set change indicator or a Next Hop Chaining Count (NCC).

25. The method of claim 19, wherein the method further comprises: checking whether the target cell relates to the set of security cells.

26. The method of claim 25, wherein the method further comprises: based on the target cell relating to the set of security cells, maintaining current security information without the security update.

27. The method of claim 19, wherein the method further comprises: informing the target cell that the wireless device had used group security information in a source cell.

28. The method of any claim 19, wherein the method further comprises: informing the target cell that the wireless device maintains group security information for next mobility.

29. The method of claim 19, wherein the wireless device is in communication with at least one of a mobile device, a network, and/or autonomous vehicles other than the wireless device.

30. A wireless device comprising:
at least one transceiver;
at least one processor; and
at least one memory operably connectable to the at least one processor and storing instructions that, based on being executed by the at least one processor, perform operations comprising:
receiving, via the at least one transceiver, information related to a set of security cells for a Primary Secondary Cell (PSCell) from a network;
performing a subsequent Conditional PSCell Addition or Change (CPAC) with a target cell, which comprises:
based on the target cell not relating to the set of security cells, performing a security update.

31. A base station comprising:
at least one transceiver;
at least one processor; and
at least one memory operably connectable to the at least one processor and storing instructions that, based on being executed by the at least one processor, perform operations comprising:
transmitting, via the at least one transceiver, information related to a set of security cells for a Primary Secondary Cell (PSCell) to a wireless device,
wherein a subsequent Conditional PSCell Addition or Change (CPAC) is performed with the wireless device and a target cell, and
wherein performing of the subsequent CPAC comprises, based on the target cell not relating to the set of security cells, performing of a security update.
